(19) United States
(12) Patent Application Publication
(10) Pub. No.: US 2026/0084045 A1
(43) Pub. Date: Mar. 26, 2026

(54) Crystal Ball for Emotional Interaction

(71) Applicant: Liu Zheng, Guangzhou City (CN)

(72) Inventor: Liu Zheng, Guangzhou City (CN)

(21) Appl. No.: 19/026,844

(22) Filed: Jan. 17, 2025

Related U.S. Application Data
(60) Provisional application No. 63/698,224, filed on Sep. 24, 2024.

(51) Int. Cl. A63F 9/18; A63F 9/24

(52) U.S. Cl. CPC A63F 9/181; A63F 9/24; A63F 2009/2402; A63F 2009/2442; A63F 2009/2454; A63F 2009/2479; A63F 2009/2488; A63F 2250/025

(57) ABSTRACT

This invention relates to a crystal ball for emotional interaction, featuring a touch-sensitive surface, a lighting system, a vibration mechanism, and a wireless communication module. When a user interacts with the touch-sensitive surface, the control system generates synchronized light and vibration outputs that are transmitted to a paired crystal ball, allowing for real-time emotional communication between remote users. The lighting system creates dynamic visual effects, including expanding or shrinking halos across the spherical surface, representing different emotional states. This system offers a tangible and immersive means of emotional expression, blending modern technology with the symbolic essence of traditional crystal balls.

### CROSS-REFERENCE TO RELATED APPLICATIONS

This application claims priority to U.S. Provisional Application No. 63/698,224, filed on Sep. 24, 2024, the disclosure of which is incorporated herein by reference in its entirety.

### FIELD OF THE INVENTION

The present invention relates to interactive devices, and more specifically, to emotional communication crystal balls utilizing synchronized light and vibration patterns. These devices are designed to enable emotional interactions between remote users through touch-sensitive mechanisms, wireless communication, and haptic feedback.

### BACKGROUND OF THE INVENTION

Crystal balls have long held a place in folklore and fairy tales, often depicted as mystical objects capable of revealing hidden truths or connecting distant individuals. In these stories, crystal balls are imbued with an aura of mystery, much like love itself—an emotion that is often enigmatic and elusive. However, despite their symbolic association with connection and insight, traditional crystal balls available on the market lack any real interactive functionality. They serve primarily as ornamental or decorative objects, devoid of any capacity for meaningful communication or emotional interaction.

While modern digital products, such as smartphones, smart speakers and smart devices, allow for real-time communication, they often lack the sense of mystery and magic that makes emotional connections truly special. These devices focus on functionality but fail to capture the deeper emotional nuances of communication—leaving a gap between practical interaction and the enchanting experience of feeling connected on a more emotional and symbolic level.

In today's increasingly digital and connected world, there remains a need for devices that not only provide aesthetic appeal but also foster real emotional engagement between users, particularly those separated by physical distance. While traditional crystal balls have historically represented a bridge to the unknown or the distant, there exists no crystal ball on the market that can function as an interactive tool for emotional communication.

The present invention seeks to fill this gap by introducing a crystal ball that harnesses modern technology to create a tangible and emotional connection between users through synchronized lighting and haptic feedback. By merging the mystical and magical elements traditionally associated with crystal balls with real-time emotional communication, this invention transforms the crystal ball into a medium for expressing emotions in a way that transcends ordinary digital interactions.

### SUMMARY OF THE INVENTION

The present invention is directed to a novel system for emotional interaction using a pair of crystal balls. Each crystal ball is equipped with a touch-sensitive mechanism, a lighting system, a vibration mechanism, and a wireless communication module, enabling users to send and receive emotional signals through synchronized light flickers and vibrations that mirror human heartbeat frequencies. By combining these technological elements with the aesthetic and symbolic qualities of a crystal ball, this invention provides an immersive and magical way for individuals to communicate their feelings in real time, bridging the gap between practical functionality and emotional expression.

Each crystal ball is designed with a spherical body supported by a base, with the touch-sensitive mechanism allowing users to interact intuitively with the device. When a user touches the surface of one crystal ball, the control system interprets the input and generates corresponding light and vibration outputs. These outputs are synchronized with a paired crystal ball, allowing for real-time emotional interaction between remote users.

The lighting system and vibration mechanism are further configured to represent various emotional states through distinct patterns of light and vibration, providing a more nuanced communication experience. These patterns may include different colors, intensities, and vibration rhythms, allowing users to convey complex emotions beyond simple signals. Additionally, the frequencies of the light flickering and vibration outputs are designed to mimic the natural range of human heartbeat frequencies (approximately 30 to 300 beats per minute), enhancing the emotional resonance of the interaction.

In one embodiment, the system comprises two or more crystal balls that are wirelessly connected to synchronize their outputs. The system not only supports real-time interaction but also allows for a recording and storage feature that logs the interaction history between paired crystal balls, preserving the emotional exchanges for future reference.

The invention also contemplates various methods of emotional interaction. In one method, users initiate emotional exchanges by interacting with the touch-sensitive mechanism, generating synchronized light and vibration feedback that is transmitted between paired crystal balls. Another method involves the use of a mobile application, which allows users to control and customize the crystal ball's functions remotely, as well as trigger light and vibration patterns in the paired device.

Additionally, the invention includes a method for confirming relationship status through a simultaneous interaction ritual. When users engage with their paired crystal balls at the same time, the system triggers a specific sequence of light and vibration, symbolizing mutual emotional acknowledgment and connection.

The crystal ball system, by combining modern touch-sensitive technology, haptic feedback, and wireless communication, transforms the traditional crystal ball from a decorative object into a powerful tool for emotional interaction. It bridges the gap between functional digital communication and the emotional depth of personal connection, creating a magical and immersive experience for users. The invention, therefore, provides an innovative and symbolic medium for emotional communication, fostering closeness and connection between individuals, regardless of physical distance.

### BRIEF DESCRIPTION OF DRAWINGS

The present invention and its advantages as described according to the drawings are given as exemplary embodiments and detailed description of the specific embodiments shown in the attached drawings shall not be interpreted as limiting. In the drawings:

FIG. 1 illustrates a crystal ball according to a preferred embodiment of the present invention;

FIG. 2 is a sectional view of a crystal ball in accordance with the preferred embodiment of the present invention;

FIG. 3 schematically illustrates an example of synchronization between a pair of crystal balls in accordance with the present invention;

### DETAILED DESCRIPTION OF THE INVENTION

The disclosure may be more completely understood in consideration of the following detailed description of various embodiments of the disclosure in connection with the accompanying drawings. The following description is based on the illustrated specific embodiments of the present invention, and should not be regarded as limiting other specific embodiments of the present invention that are not described in detail herein.

The word “embodiment” used in this specification means serving as an example, example, or illustration. In addition, the article “a” used in this specification and appended claims can generally be construed as meaning “one or more” unless specified otherwise or clearly directed to the singular form from the context.

In the description of the present invention, it should be understood that the terms “center”, “longitudinal”, “transverse”, “length”, “width”, “thickness”, “upper”, “lower”, “front”, ““Back”, “Left”, “Right”, “Vertical”, “Horizontal”, “Top”, “Bottom”, “Inner”, “Outer”, “Clockwise”, “Counterclockwise” and other directions are positional relationships based on the position or positional relationship shown in the drawings, and is only for the convenience of describing the present invention and simplifying the description, and does not indicate or imply that the pointed device or element must have a specific orientation, be constructed and operated in a specific orientation, Therefore, it cannot be understood as a limitation to the present invention.

In the description of the present invention, it should be noted that the terms “set” and “connected” should be understood in a broad sense unless otherwise clearly specified and limited. For example, they can be fixed or detachable. Connected or integrally connected; it can be mechanically connected, or it can be electrically connected or can communicate with each other; it can be directly connected, or indirectly connected through an intermediate medium, it can be the internal communication of two components or the interaction of two components in relationship. For those of ordinary skill in the art, the specific meaning of the above-mentioned terms in the present invention can be understood according to specific circumstances.

In addition, unless expressly stipulated and defined otherwise, the “above” or “below” of the first feature of the second feature may include the first and second features in direct contact, or the first and second features are not in direct contact but through the contact of other features between them. Moreover, “above” the second feature of the first feature includes the first feature being directly above and obliquely above the second feature, or indicating that the first feature is higher in level than the second feature. The “below” the first feature of the second feature includes the first feature directly below and obliquely below the second feature, or that the level of the first feature is lower than the second feature.

The following disclosure provides many different embodiments or examples for realizing different structures of the present invention. In order to simplify the disclosure of the present invention, the components and settings of specific examples are described below. Of course, they are only examples, and the purpose is not to limit the present invention. In addition, the present invention may repeat reference numerals and/or reference letters in different examples, and this repetition is for the purpose of simplification and clarity, and does not indicate the relationship between the various embodiments and/or settings discussed. In addition, the present invention provides examples of various specific processes and materials, but those of ordinary skill in the art may be aware of the application of other processes and/or the use of other materials.

The present invention relates to a crystal ball designed for emotional interaction, combining modern technology with the symbolism traditionally associated with crystal balls. The invention allows for real-time emotional communication between users through synchronized light and vibration patterns. The following is a detailed description of the embodiments illustrated in the accompanying drawings.

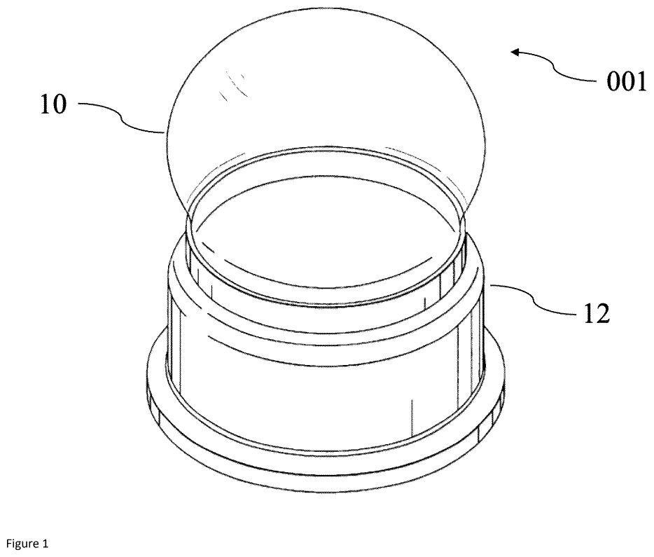

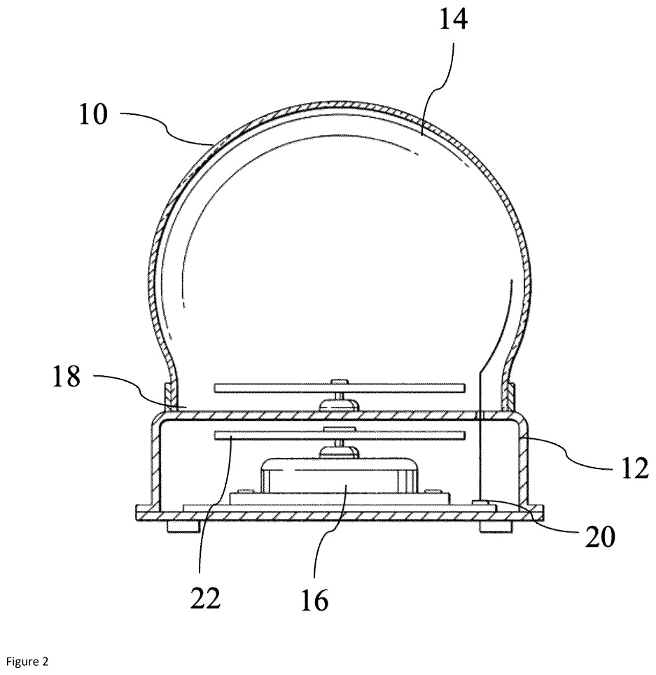

Referring to FIGS. 1-3 in the drawing, a crystal ball 001 comprises a spherical body 10 and a base 12. The spherical body 10 is constructed from a transparent or semi-transparent material, which serves as a touch-sensitive mechanism 14 allowing users to interact with the device by touching or tapping the surface. The base 12 is designed to support the spherical body 10 and houses internal components such as the control system 16.

The lighting system 18, located inside the spherical body 10, is configured to produce a variety of colors and patterns based on user input. When a user interacts with the touch-sensitive mechanism 14, the control system 16 interprets these inputs and triggers corresponding lighting outputs, which can be synchronized with a paired crystal ball 002 in short distance via a wireless communication module 20 or in long distance via network 170. The lighting effects can represent different emotional states, with specific colors or patterns indicating distinct emotions.

In another embodiment, the crystal ball further includes a vibration mechanism 22 located within the base 12. This vibration mechanism provides haptic feedback that corresponds to the user's touch inputs. The control system 16 processes the touch inputs and generates synchronized vibration outputs, which are transmitted to a paired crystal ball through the wireless communication module 20. The vibration outputs are synchronized so that the paired crystal ball mirrors the interaction, thereby fostering an emotional connection between users through tactile feedback.

The method of using the crystal ball for emotional interaction involves several key steps. First, the touch-sensitive mechanism 14 detects user input, such as a tap or prolonged touch. This input is then processed by the control system 16, which generates corresponding light and vibration feedback. The feedback is transmitted wirelessly to a paired crystal ball via the wireless communication module 20. The paired crystal ball receives the transmitted feedback and displays it through synchronized light and vibration outputs. This method allows users to convey emotional messages to one another, even when physically distant, through a simple and intuitive interaction.

In one embodiment, the lighting system 18 and vibration mechanism 22 are configured to express various emotional states through specific patterns of light and vibration. For example, a soft, pulsing blue light might indicate calmness, while a rapid red flicker could represent excitement or urgency. The vibration mechanism can also be programmed to mirror heartbeat frequencies, with faster vibrations suggesting excitement or nervousness, and slower pulses conveying relaxation or contentment. The combination of light and vibration enables a rich emotional experience, with the two outputs working together to convey complex emotional signals between users.

In one embodiment, the frequencies of the light flickering and vibration are within the range of human heartbeat frequencies, enhancing the emotional resonance of the interaction. This feature allows users to feel a deeper connection with their paired crystal ball, as the feedback mimics the natural rhythm of a heartbeat, adding an intimate, personal element to the emotional communication.

In one embodiment of the present invention, the lighting system 18 is configured to generate light flickers within the range of human heartbeat frequencies that travel along the surface of the spherical body 10. This flickering effect can be visually represented as a gradually shrinking or enlarging circular or spherical halo, creating a dynamic and engaging visual display for users. The light emanates from within the sphere and moves outward or inward in smooth, continuous motions.

For example, when a user touches the surface of the crystal ball, a soft glow may appear at the point of contact, and then expand outward in a circular halo across the surface of the sphere. This halo can gradually increase in size, illuminating the surface until it fades at the edges, mimicking the way emotions might grow or spread in intensity. Conversely, the halo can also contract, starting as a larger glowing circle or spherical shape and gradually shrinking to a smaller point, symbolizing a fading or calming emotional state.

This lighting effect not only enhances the aesthetic appeal of the crystal ball but also conveys emotional nuance through visual cues. A slowly enlarging halo, for instance, might represent feelings of warmth, affection, or excitement, while a shrinking halo might suggest introspection, relaxation, or the gradual calming of intense emotions.

Furthermore, the speed, color, and intensity of the expanding or shrinking halo can be customized to reflect specific emotional states. A fast-expanding bright red halo could indicate excitement or urgency, while a slow, shrinking blue halo may suggest calmness or contentment. The flexibility of the lighting patterns allows users to convey complex emotional messages through simple interactions with the crystal ball, enhancing the emotional connection between paired devices.

In addition, the lighting system can be synchronized with the paired crystal ball, allowing both devices to display the same enlarging or shrinking halo effect simultaneously. This synchronized visual output mirrors the emotional communication between users, ensuring that both participants experience the same emotional display, regardless of physical distance.

The system comprises two or more crystal balls, each of which can communicate with the others through the wireless communication module 20. When a user interacts with one crystal ball, the touch input is processed and transmitted to the paired crystal ball(s). The paired devices synchronize their lighting and vibration outputs to reflect the same emotional state, allowing multiple users to share a synchronized emotional experience, regardless of their physical location.

In one embodiment of the present invention, the synchronization of the paired crystal balls is facilitated by near-field communication technologies, such as WiFi, Infrared, or similar short-range wireless protocols. These technologies enable seamless real-time communication between the crystal balls, allowing users to experience synchronized lighting and vibration effects, even when they are physically separated.

When a user interacts with one crystal ball, for example by tapping or touching its touch-sensitive mechanism 14, the control system 16 detects the input and generates corresponding outputs in the form of light and vibration patterns. These outputs are not limited to the originating crystal ball but are wirelessly transmitted to the paired device via the near-field communication module.
WiFi Connection: In one scenario, the paired crystal balls are connected through a local WiFi network, allowing the devices to synchronize their emotional responses across greater distances, such as between rooms or even different buildings. This WiFi connectivity ensures a stable, long-range communication channel, where inputs on one crystal ball are instantly transmitted to the paired device, and both crystal balls display synchronized emotional outputs in the form of expanding or shrinking light halos and matching vibration patterns.
Infrared Communication: Alternatively, for shorter-range interaction or for users in close proximity, Infrared technology can be employed. This method allows the paired crystal balls to communicate directly without the need for a WiFi network. When placed within a specific range of each other, the Infrared signals transmit the emotional feedback from one crystal ball to another, ensuring that both devices mirror the same light flickering and vibration outputs, creating an immediate emotional connection between users.
Other Near-Field Technologies: In addition to WiFi and Infrared, the crystal ball system can support other near-field communication technologies such as Bluetooth or RFID. These technologies offer flexibility depending on the distance between the paired devices and the user's preferences. For instance, Bluetooth may be used for shorter, more intimate interactions, where the devices remain in close proximity, while RFID can enable quick pairing and communication when the devices are brought into range of one another.

The synchronization enabled by these near-field technologies ensures that the emotional messages conveyed through touch, light, and vibration are shared instantaneously and precisely between the paired crystal balls. The use of such wireless communication methods allows users to maintain a deep emotional connection, regardless of their physical distance, offering a seamless and intuitive way to share emotions in real-time.

In another embodiment, the crystal ball includes a feature for recording and storing interaction history. This allows users to revisit past emotional exchanges, preserving the emotional connections that were shared. The history can be stored within the crystal ball's memory or in a connected mobile application, which also offers remote control and customization features for the crystal ball.

One unique method of using the crystal ball is for confirming relationship status through a simultaneous interaction ritual. In this method, two users engage with their respective crystal balls at the same time. The system detects the simultaneous interaction and triggers a special sequence of light and vibration patterns on both crystal balls, symbolizing a shared emotional connection. This sequence can serve as a confirmation of relationship status, whether romantic, familial, or friendship-based.

In another embodiment, the crystal ball system can be controlled and customized through a mobile application. The app allows users to remotely trigger light and vibration patterns on their paired crystal balls, enabling emotional communication even when not physically near the device. The app also offers customization options, such as adjusting the colors, vibration intensities, and specific patterns to suit personal preferences or specific emotional messages.

The present invention offers a unique and innovative approach to emotional communication, combining the symbolic nature of crystal balls with modern touch-sensitive technology, synchronized lighting, and haptic feedback. Through these features, users are able to communicate emotions in real time across distances, creating a tangible and meaningful connection that transcends traditional digital interactions.

Spherical Body with Touch-sensitive mechanism: The core of the crystal ball is a spherical body that houses all the functional components. This body is equipped with a touch-sensitive mechanism allowing users to interact with the crystal ball through touch. The base of the crystal ball is engineered to support the spherical structure and stabilize it on various surfaces, enhancing its usability.

Lighting System: Incorporated within the spherical body is a lighting system. This system can emit light in various colors and intensities, which can be controlled through touch interactions or remotely via a connected crystal ball. The lighting system serves as a visual feedback mechanism for interactions, changing colors or intensity based on the user's input or the input from a connected crystal ball.

Vibration Mechanism for Haptic Feedback: To enrich the user experience with tactile feedback, the crystal ball includes a vibration mechanism. This mechanism activates in response to specific interactions, providing a physical dimension to the feedback that complements the visual cues from the lighting system.

Wireless Communication Module: The crystal ball features a wireless communication module that enables it to pair with an identical crystal ball. This pairing allows for synchronized or responsive interactions between two crystal balls, regardless of their physical location, as long as they are connected over a network. The communication module facilitates the exchange of data and commands that trigger corresponding outputs in each crystal ball.

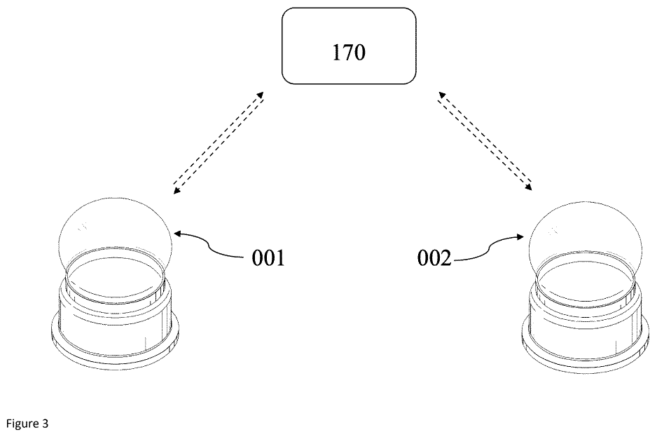

Control System: At the heart of the crystal ball's functionality is a control system that interprets touch inputs on the spherical surface. This system processes the inputs to activate the lighting and vibration mechanisms accordingly. It translates the touch data into specific outputs, creating a reactive experience that mirrors or complements the interactions received from a paired crystal ball. FIG. 3 schematically illustrates an example of a system 100 in accordance with the present invention for enabling emotional communication between users through interconnected crystal balls. These crystal balls use network-connected light and vibration sources to communicate across a distance with other associated paired or grouped crystal balls. A first light-emitting crystal ball 110 and a second light-emitting crystal ball 120 are shown in the example of FIG. 3, though additional crystal balls may be integrated into the system in accordance with the present invention.

In the example of FIG. 3, the first crystal ball 110 uses a wireless connection to communicate with a network router. For example, network router may comprise a wireless router, and the wireless connection may facilitate communication between the first crystal ball 110 and the router using a wireless communication protocol. The network router connects via connection, through any media or protocol, to a network 170, such as the Internet. Similarly, the second crystal ball 120 may also wirelessly connect to another network router, which in turn connects to the network 170, such as the Internet.

A server may connect via connection to network 170. Server facilitates communication between first crystal ball 110 and second crystal ball 120, allowing the exchange of packet-based information. This server may manage and route data between crystal balls, enabling real-time synchronization of emotional feedback through light and vibration signals. Each crystal ball in the system may be assigned a unique identifier during manufacturing, allowing it to be recognized by the server and paired with another crystal ball, ensuring privacy and seamless communication.

In the operation of system 100, when a user interacts with first crystal ball 110 by touch or other physical inputs, first crystal ball 110 transmits corresponding signals to server. Server processes these inputs and relays the emotional signal to second crystal ball 120, which may result in a change in light emission, color, or vibration feedback on the second crystal ball 120. This functionality enables emotional synchronization across distances, allowing two users to share non-verbal emotional signals through a multi-sensory experience.

For instance, upon activation of first crystal ball 110, a pink light might be emitted, symbolizing love or warmth, while a corresponding vibration pattern reflects a heartbeat, emphasizing emotional connection. This activation triggers a corresponding change in second crystal ball 120, which could reflect the same light color and vibration pattern, creating a synchronized emotional response between the two crystal balls.

The invention further allows for a variety of light source types, including but not limited to light-emitting diodes (LEDs), incandescent bulbs, and other light-generating technologies. Each crystal ball may consist of multiple light elements capable of emitting diverse light patterns based on user input.

A key feature of this invention is the combination of light and vibration feedback. A remote crystal ball (e.g., second crystal ball 120) may trigger changes in the local crystal ball (e.g., first crystal ball 110), and vice versa, facilitating two-way communication. These changes may include:
Light emission with variable colors (e.g., pink for love, blue for calmness, red for excitement),
Alterations in light intensity, flashing, or duration,
Customizable vibration feedback patterns (e.g., soft vibrations for care, rhythmic vibrations for heartbeat).

The server ensures that users can communicate regardless of geographic distance. To maintain an open communication channel between crystal balls and server, a persistent connection is established. Should the connection drop, crystal balls attempt to reconnect automatically, ensuring continuous communication.

A lighting crystal ball may use a plurality of electrical components provided on one or more printed circuit board. Printed circuit board may contain a plurality of circuit elements and micro-controllers to permit a lighting crystal ball to operate as described herein. Printed circuit board may have a size and shape that permits it to be mounted on a base and/or contained within a shade assembly or other housing when the lighting crystal ball is assembled for use. A plurality of holes may be provided to receive screws to retain printed circuit board to base and, if a capacitive sensing system as described in examples herein is used, to establish reliable electrical connections between elements of circuit board and input regions on lighting crystal ball. Input regions may comprise a conducting portion of a shade panel, a conductive portion of a frame that retains one or more shade panel, a conductive portion of a base, or any other input mechanism electrically connected to printed circuit board. In some examples of systems and methods in accordance with the present invention, a printed circuit board may be replaced, in whole or in part, but electrical connections between the electrical components described in conjunction with the example of FIG. 3.

Printed circuit board may provide a plurality of elements that emit light, such as a plurality of LEDs, to produce light in response to an input received from a user locally and/or in input received from a remote user at a remote first Crystal ball associated with the local lighting crystal ball. For example, sixteen light emitting diodes may be arranged in a circular fashion, but more or fewer LEDs in different geometric arrangements, or even light emitting elements other than LEDs, may be used with a first Crystal ball in accordance with the present invention. The LEDs may be capable of emitting light at a variety of wavelengths and/or a variety of intensities. The wavelength of emitted light, the intensity of emitted light, and which of the plurality of diodes is activated to emit light at a given wavelength or intensity may be controlled using circuitry and/or software provided elsewhere on the lighting crystal ball. One example of LEDs that may be used in accordance with the present invention are RGB LEDs connected in a daisy chain and (optionally) individually addressable by a micro-controller. A lighting crystal ball having individually addressable LEDs may adjust the on/off status, color, and/or intensity of single LEDs (or groups of LEDs, if desired) simultaneously.

In another embodiment, the lighting system within the crystal ball utilizes a versatile LED light source that can be configured in various forms, such as a light bar with multiple concentric circles or a mini LED light board. These LED configurations provide a dynamic range of lighting effects, offering users a visually immersive experience that enhances the emotional interaction between paired crystal balls.
Light Bar with Concentric Circles: The light bar is composed of multiple concentric rings of LEDs, arranged to cover different regions of the spherical body or the base. Each LED ring can be individually controlled to adjust the number, sequence, and frequency of light flashes. This configuration allows for the creation of dynamic light patterns that simulate a heartbeat light aperture, where the light pulses rhythmically in a manner reminiscent of a human heartbeat. The concentric circles can illuminate sequentially, starting from the innermost ring and moving outward, or vice versa, to create the visual effect of expanding or contracting light halos. This gradual illumination mirrors the ebb and flow of emotional intensity, providing a symbolic representation of emotional states such as excitement, affection, or calm.

For example, when a user touches the crystal ball, the innermost ring of LEDs may pulse first, followed by the next outer ring, and so on, creating a gradually enlarging light halo that mimics the natural rhythm of a heartbeat. This effect can also be reversed, where the outer rings illuminate first and contract inward, simulating a calming or soothing emotional response.

Mini LED Light Board: Alternatively, the lighting system can feature a mini LED light board, offering precise control over individual LED clusters. The mini LED board allows for intricate light displays, where each small LED can be programmed to flash in specific sequences, colors, and intensities. By controlling the number and frequency of flashes, the mini LED light board can produce complex patterns that simulate emotional states, such as a fast, pulsing light sequence to indicate excitement or a slow, steady pulse to reflect relaxation.

In another embodiment, the mini LED light board can simulate a heartbeat-like pattern by adjusting the flash frequency to correspond with typical human heartbeat rates, creating a rhythmic pulsation that conveys emotional intensity. The light board can also be synchronized with the vibration mechanism (20), so that both the light and vibration outputs mimic the rhythm of a heartbeat, providing tactile and visual feedback simultaneously.

Customization of Light Effects: Whether using a light bar with concentric circles or a mini LED light board, the number, sequence, and frequency of flashes can be customized by the user via the control system or a connected mobile application. Users can select from a variety of predefined light patterns that represent different emotional states, or they can create personalized patterns by adjusting the speed, brightness, and rhythm of the light flashes. For example, a user may choose to slow down the frequency of flashes for a more soothing emotional message or increase the frequency for a more urgent or excited signal.

The LED light source is not only capable of producing static light effects but can also create moving visual patterns that enhance the interactive experience. The light can shift in color and intensity, creating a rich visual language that corresponds to the emotional message being communicated.

This LED lighting system enhances the overall sensory experience of the crystal ball, making it more than a simple visual display. It transforms the crystal ball into a dynamic emotional communicator, where the heartbeat-like pulsations of the light bar or the mini LED board reflect the emotional connection between paired devices, reinforcing the bond between users through synchronized light effects.

A wireless connection module may be provided as part of first Crystal ball 110. A wireless connection module may comprise, for example, one or more antenna and the appropriate hardware to operate in accordance with a wireless communication protocol, such as one of the protocols (referred to commonly asked “Wi-Fi”), a Bluetooth protocol, a Zigbee protocol, or other communication protocols. A wide variety of modules that may be used as a wireless connection module are commercially available, one example of which is an ESP8266-12e FCC-certified COTS WiFi module available from Espressif Systems (Shanghai) Pte. Ltd.

First Crystal ball 110 may receive power from a power source such as an electrical outlet and/or a battery. Power may be regulated using a voltage regulator to provide power at a voltage acceptable and appropriate to the other electric components of first Crystal ball 110. The type and voltage rating a voltage regulator used in accordance with the present invention, as well as whether a voltage regulator is used at all, may vary based upon the electrical components used in lighting crystal ball. One example of a voltage regulator that may be used in systems and methods in accordance with the present invention is a regulator that receives a 5V input and provides a 3.3V regulated output.

An activation sensing circuit may receive physical inputs from a local user. In an example further described herein, capacitance sensing is used to detect a touch from a user, but other types of inputs, such as buttons, levers, dials, keyboards, motion detectors, sound responsive sensors, voice recognition systems, load sensors, light detection, or other input crystal balls may provide physical inputs from a local user that are received by activation sensing circuitry. In the example of a lighting crystal ball 200 operated using touch inputs detected by activation sensing circuit, an activation sensing circuit may comprise a sensor such as an AT42QT1010 sensor available from Atmel Corporation, although many different sensors may be used in the example of a lighting crystal ball operated by receiving user inputs based upon capacitive sensing. If capacitive sensing is used in a first Crystal ball 110 in accordance with the present invention, a reliable electrical contact must be made between the activation sensing circuit(s) and the touch surface(s) of first Crystal ball 110 that are to receive those inputs.

A level shifter may control the response of first Crystal ball 110, particularly the activation status, wavelength, and/or intensity of LEDs activated by lighting crystal ball. Level shifter may receive inputs from activation sensing circuit and/or inputs from wireless communication module corresponding to inputs received at a second crystal ball 120. Level shifter may additionally relay locally received inputs from a user to the wireless communication module for transmission to a second crystal ball 120 associated with the first Crystal ball 110.

Level shifter may further control the activation of one or more LED even in absence of an input by adjusting the operation of one or more LED based upon the time lapsed since one or more prior input. For example, an input received may initially activate the LEDs at a given intensity, which may then gradually reduce the intensity over a period of time, such as five minutes, thirty minutes, an hour, or multiple hours. Further, the operation and response of LEDs may vary based upon parameters such as the time of day, the last input received, the type of input received, etc. Level shifter may comprise various types of digital and/or analogue circuits, such as a micro-controller. One example of a micro-controller that may be used with systems and methods in accordance with the present invention is a BSS138 N-Channel Logic Level Enhancement Mode Field Effect Transistor available from Fairchild Semiconductor, although other microprocessors may be used without departing from the scope of the present invention.

In another embodiment, a first Crystal ball 110 having a discrete activation sensing circuit, wireless communication module, and level shifter, the functionality of these components may be combined into fewer or distributed into more components. For example, a first Crystal ball 110 that receives only touch inputs from a local user and does not distinguish between different types of touches may provide elegant simplicity of use, but first Crystal ball 110 in accordance with the present invention may receive a variety of different inputs that result in different responses by the illumination elements of the first Crystal ball 110.

A base sheet may be comprised of wood, poly-carbonate, glass, thin paper, or any other material having physical properties suited to a use environment and a user's preferences.

An example method for forming a plurality of sheets into a shade for use with a first Crystal ball 110. The method may begin with step S1, in which a sheet may be printed with a nonconducting ink having a color and/or pattern that is aesthetically pleasing. In step S2, the sheet may be printed with a conducting ink to provide capacitive sensing capabilities to a shade constructed from the sheet. In step S3, the sheet may be cut to form a plurality of panels. The number of panels to be cut in step S3 may be four, but may be more or fewer. One or more of the panels cut in step S3 may include a top portion for the shade to be formed or may serve as a top portion for the shade to be formed. In step S3, the sheets may be assembled to a base. Step S3 may be performed before or after step S1 and/or step S2. The panels may be assembled with the conducting ink oriented outwards, toward a user, or may be assembled with the conducting ink oriented inward, or away from a user. Capacitive sensing detects proximity of a touch to a conductor and, in many examples, the thickness of a panel and the material from which a panel is constructed does not inhibit detection of a touch (or a near-touch) on the un-inked surface of a panel. Step S4 may establish appropriate electrical connections between the conducting ink applied in step S3 and activation sensing circuitry, such as depicted as activation sensing circuitry. Step S4 may involve providing conducting ink at an edge of the panels and installing the panels to a base (such as base 410) to contact a conductor (such as conductor). In this fashion, when a user touches a sheet, the capacitance change resulting from that contact may be detected by the activation sensing circuitry. The activation sensing circuitry may use the analog capacitance change over time as a trigger to detect an input, i.e. to activate if the capacitance changes more than a given amount within a certain period of time. In this fashion, the activation sensing circuitry may alter the behavior of the light emitted by the first Crystal ball 110 if a touch is detected.

In another embodiment of the operation of one of two or more associated first Crystal ball 110 is illustrated. Method may begin with the power on step S11 which may permit the configuration of the first Crystal ball 110 for a period of time after the first Crystal ball 110 is connected to a power source. For example, step S11 may permit the wireless network connectivity of the first Crystal ball 110 to be configured, to associate the first Crystal ball 110 with another second crystal ball 120, to create a password for future modifications, to determine the responses made by the first Crystal ball 110 to various local or remote inputs, to set time parameters for the modification of illumination as a function of time, to set certain times during which the response of the first Crystal ball 110 to messages from associated remote second Crystal ball 120 will be reduced or eliminated (for example, to prevent an activation from waking a sleeping user), and the like. Step S11 may also access a server to check for firmware or software updates.

After the power up and/or set up of step S11 has concluded, method 700 may proceed to step S12 to determine whether a local user input has been received. A local user input may be received, for example, using a capacitance sensing system such as described above. If the conclusion of step S12 is that a local user input has been received, method 700 may proceed to step S13 and step S14. If the conclusion of step S12 is that no local user input is received, method may proceed to step S15.

In step S11, the lighting crystal ball is configured. This configuration may occur within a predetermined time period (e.g. two minutes) after the crystal ball is first connected to a power source. During configuration, the crystal ball transmits a “Soft AP” or “Access Point” signal, allowing a user to connect to it using a Wi-Fi enabled crystal ball such as a smartphone, tablet, or computer. The user may need to enter authentication information provided with the product to access the configuration interface.

Configuration in step S11 may include:
Setting up Wi-Fi network connection details
Associating the crystal ball with other lighting crystal balls
Defining how the crystal ball's lights should respond to various inputs
Setting time periods for limited or no response to messages
Specifying the local time zone
Other operational parameters

After configuration, in step S12, the method checks for local user input. This input may be detected through a touch-based interface on the lighting crystal ball.

If local input is detected, the method proceeds to step S13, where local light elements (such as LEDs) are activated based on the input and the configuration from step S11. This activation may involve:
Switching lights on or off
Changing light color or intensity
Altering flash patterns
Other light behavior modifications

The specific activation may vary based on factors like time of day or the current state of the crystal ball. In some embodiments, each input cycles the crystal ball through predetermined levels of activation.

Following local activation, in step S14, the crystal ball sends a control message to one or more associated remote lighting crystal balls. This message may be routed through intermediate servers and is designed to trigger a corresponding light activation on the remote crystal ball(s).

If no local input is detected in step S12, or after steps S13 and S14 are completed, the method proceeds to step S15. Here, it checks for incoming control messages from associated remote lighting crystal balls. These messages may be received via servers over a network like the Internet.

If a control message is received, the method moves to step S16, where local light elements are activated in response to the message. This activation follows similar principles to step S13, with the specific response potentially based on the configuration from step S11.

In step S17, if any light elements were activated (either from local input or a remote message), their activation level may be adjusted as a function of time. For example, the light intensity might gradually decrease until it reaches zero. The specifics of this adjustment can be part of the crystal ball configuration.

After step S17, the method returns to step S12 to continue monitoring for inputs and messages. This cycle continues until the crystal ball is powered off.

### Communication Protocol

Lighting crystal balls in the present invention may use various network protocols for exchanging information and ensuring security. Some key aspects of the communication protocol include:
1. Wi-Fi Communication: Crystal balls use SSL/TLS 1.2 protocol for secure Wi-Fi communication.
2. Crystal ball Identification: Each crystal ball has a unique identifier, potentially derived from its wireless communication module.
3. Start-up Procedure:
   Crystal ball attempts to connect to stored Wi-Fi networks
   Upon successful connection, it contacts a server to check for software/firmware updates
   Crystal ball then connects to an MQTT broker for ongoing communication
4. MQTT Communication:
   Crystal balls subscribe to individual and group channels
   Messages are typically in JSON format
   Crystal balls ignore their own messages relayed back through the broker
5. Time Synchronization: Crystal balls may use server-provided timestamps to maintain accurate local time without a built-in real-time clock.
6. Security Measures:
   Use of private keys and API keys for authentication
   Client ID prefixes for additional security layer
   SSL/TLS encryption for all network communication

### Status Indication

Lighting crystal balls may use light patterns to indicate their status:
Slow green pulse: Searching for Wi-Fi
Rapid orange pulse: No known Wi-Fi found
Red light: Searching for software update
Green light: Handshake with server in progress
Multi-color “rainbow”: Successful power-up
Fast blue pulse: Wi-Fi connected but no Internet
Fast red pulse: Security certificate failure
Slow purple pulse: Configuration mode

These visual indicators provide users with immediate feedback on the crystal ball's operational state without requiring additional displays or interfaces.

When a user interacts with the first crystal ball by touching it, the crystal ball responds with a multi-sensory output designed to mimic the rhythm and feel of a heartbeat. This response includes:
1. Visual feedback: The crystal ball emits a ripple-like pattern of light. This light pattern originates from the point of touch and spreads outwards in concentric circles, similar to ripples on water. The light pulses at a frequency closely matching that of a typical resting human heart rate, approximately 30-300 beats per minute.
2. Haptic feedback: Simultaneously with the light emission, the crystal ball produces a gentle vibration. This vibration is also synchronized with the light pulses, creating a tactile sensation that mimics the rhythm of a heartbeat.
3. Continuous effect: The combination of pulsing light and synchronized vibration continues for a predetermined duration after the initial touch, maintaining the heartbeat-like rhythm.
4. Remote activation: Upon activation of the first crystal ball, a control message is sent over a network to an associated second crystal ball, which may be located at a great distance from the first.
5. Synchronized response: Upon receiving the control message, the second crystal ball activates in a manner similar to the first, emitting the same ripple-like light pattern and synchronized vibration.
6. Bi-directional communication: The system allows for bi-directional interaction, meaning a touch on either crystal ball can initiate the response in both crystal balls.
7. Customization: The specific characteristics of the light and vibration, such as color, intensity, and duration, may be customizable through a configuration interface, allowing users to personalize their experience.
8. Gradual fade: After a set period of time, both crystal balls may gradually reduce the intensity of their light and vibration, slowly returning to their inactive state unless re-activated by another touch.

This interactive system creates a unique form of non-verbal, emotional communication between users, allowing them to share a simulated heartbeat experience across any distance. The combination of visual and haptic feedback in a rhythm mimicking a heartbeat creates a deeply personal and intimate form of connection, facilitated by these networked crystal balls.

The crystal ball is designed to offer an intuitive and immersive emotional communication experience, inspired by natural human behaviors such as touching, holding, or keeping close. These gestures, often tied to emotional states, are seamlessly translated into light and vibration feedback to evoke or share emotions. Below are examples of how the crystal ball supports various emotional expressions:
1. Calming Interaction: Gentle Touch for Serenity
When a user lightly strokes the touch-sensitive mechanism of the crystal ball, the system responds with slow, rhythmic pulses of light and gentle, wave-like vibrations. This effect mimics the natural rhythm of deep breathing or a steady heartbeat, which is known to promote relaxation and reduce stress.
For instance:
   Light Effect: A soft blue or green halo gradually expands and contracts across the surface of the sphere.
   Vibration Feedback: Subtle, low-frequency vibrations accompany the light, creating a tactile sense of calm.
This interaction provides comfort to the user, whether they are calming themselves or sharing a moment of serenity with a paired crystal ball user.
2. Confidence Boost: Firm Grasp for Empowerment
Holding the crystal ball firmly triggers an emotional response designed to boost confidence and energy. The ball emits a warm, steady light, such as shades of gold or orange, combined with a robust vibration pattern that mirrors a strong, steady heartbeat.
For instance:
   Light Effect: A bright, radiating glow from the core of the sphere, symbolizing inner strength and determination.
   Vibration Feedback: Strong, consistent pulses that align with the rhythm of an elevated but steady heartbeat.
This interaction is ideal for moments of self-affirmation, preparing for challenges, or when a paired user wants to send encouragement or motivation remotely
3. Shared Joy: Rapid Tapping for Excitement
When a user rapidly taps on the crystal ball, it interprets the motion as a signal of excitement or joy. The device responds with dynamic, multicolored flashes of light and rapid vibration bursts, creating a celebratory atmosphere.
For instance:
   Light Effect: A rainbow sequence of colors that spiral or scatter across the surface of the sphere.
   Vibration Feedback: Quick, high-frequency bursts that reflect the energy of excitement.
This interaction is ideal for sharing moments of happiness, such as celebrating achievements or sending joyful messages to paired users.
4. Bonding Connection: Holding Hands for Love and Affection
When two users each hold their respective paired crystal balls, the system synchronizes the lighting and vibration effects between the devices, symbolizing emotional closeness. The crystal balls emit a warm pink or red glow that pulses in unison, representing a shared heartbeat.
For instance:
   Light Effect: Alternating expanding and contracting light halos across both paired crystal balls.
   Vibration Feedback: Harmonized vibrations that mirror the rhythm of a shared, steady heartbeat.
This interaction is ideal for expressing love, affection, or solidarity, especially over long distances.
5. Encouraging Positivity: Stroking for Support
Gently stroking the crystal ball can send a message of support or encouragement to a paired user. The system responds with a combination of warm light (e.g., soft yellow or orange) and soothing vibrations that convey reassurance and positivity.
For instance:
   Light Effect: a Flowing Gradient of Warm Tones That Gently Shifts along the sphere's surface.
   Vibration Feedback: A combination of medium-frequency and wave-like patterns, providing a tactile sensation of being “there” for the user. This feature is especially useful for comforting someone in need or offering a “virtual hug. ”
6. Reflecting Self-Expression: Customized Interactions for Unique Feelings
The crystal ball allows users to create personalized light and vibration patterns to represent their unique emotional expressions. For example, a user might design a pattern of pulsing purple light with swirling vibrations to symbolize creativity or an invigorating white strobe paired with fast vibrations to represent inspiration.
By enabling such customization, the crystal ball becomes a personal tool for emotional expression, adaptable to a wide range of moods and sentiments.
7. Mindfulness and Focus: Steady Holding for Grounding
In moments of distraction or stress, simply holding the crystal ball can ground the user and promote mindfulness. The system generates a slow, steady glow that transitions between soft white and pastel shades, accompanied by faint, rhythmic vibrations. This creates an environment of focus and clarity.
For instance:
   Light Effect: A calm, slowly pulsating glow that moves in and out like a meditative breath.
   Vibration Feedback: Gentle, consistent vibrations that mirror a focused state of mind.
This interaction is particularly useful for meditation, study, or other activities requiring concentration.

By mimicking these intuitive gestures and tying them to corresponding emotional feedback, the crystal ball bridges the gap between technology and human connection. It provides a powerful way to communicate and share emotions across distances, blending light, vibration, and touch to create meaningful experiences for its users.

1. A crystal ball for emotional interaction, comprising:
a spherical body and a base configured to support the spherical body;
a touch-sensitive mechanism;
a lighting system;
a wireless communication module configured to pair with a second crystal ball; and
a control system configured to interpret touch inputs and convert them into corresponding light outputs, wherein the light outputs are synchronized between the paired crystal balls.

2. The crystal ball of claim 1,
further comprising a vibration mechanism for providing haptic feedback, wherein the control system interprets touch inputs and converts them into corresponding vibration outputs, and wherein the vibration outputs are synchronized between the paired crystal balls.

3. The crystal ball of claim 2, wherein the vibration mechanism is configured to generate vibration frequencies corresponding to a human heartbeat to evoke emotional responses.

4. The crystal ball of claim 3,
wherein the flashing frequency of the lighting system and vibration frequency the vibration mechanism are in the range of human heartbeat frequencies.

5. The crystal ball of claim 1,
wherein the lighting system includes a light source that forms a gradually shrinking or enlarging circular or spherical halo to represent user's emotional states.

6. The crystal ball of claim 1,
further comprising a memory configured to record and store interaction history between paired crystal balls.
